(19) United States
(12) Patent Application Publication
(10) Pub. No.: US 2005/0197771 A1
(43) Pub. Date: Sep. 8, 2005

(54) Potential accident detection assessment wireless alert network

(76) Inventors: Ryan E. Seick, Palatine, IL (US); Ramy P. Ayoub, Arlington Heights, IL (US); Vijay S. Raisinghani, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 10/795,004

(22) Filed: Mar. 4, 2004

(51) Int. Cl. G06F 19/00; G01C 21/28

(52) U.S. Cl. 701/301; 701/213

(57) ABSTRACT

Disclosed herein are systems and methods for detecting a potential collision between a plurality of vehicles and alerting the operator to the potential collision. If the operator fails to heed the alert, the system may also assume control of the vehicle until the dangerous situation is passed. In connection with these systems, each vehicle is equipped with a telematics system that defines a safe perimeter around the vehicle. The safe perimeter is constantly changed in response to the velocity and acceleration of the vehicle. The telematics system is in communication with the telematics systems of other vehicles in the vicinity and the systems exchange data about the current extent of their safe perimeters. If a telematics system detects the impingement of one of the other safe perimeters into its safe perimeter, the alert is triggered.

### FIELD OF THE INVENTION

This invention relates to systems and methods for detecting a collision hazard between two vehicles and alerting the operators of the vehicles to the hazard.

### BACKGROUND

Communication and informational systems in vehicles continue to grow more powerful, thus providing increasing convenience to vehicle occupants. For example, some vehicles are now equipped with relatively sophisticated computer systems to enhance the driving experience and to provide useful information to vehicle occupants. Such vehicle-based systems may also wirelessly communicate with even more powerful computing systems external to the vehicle. Additionally, it is possible for such systems to communicate wirelessly with similar systems in other vehicles.

An increasingly popular computerized feature found in some vehicles is a navigation system. Such systems come in a variety of forms, and a relatively common feature of such systems is that the vehicle in such a system will be equipped with some sort of location-specifying device, such as a Global Positioning System (GPS) device. Although these systems have their primary use in navigation, if vehicles having systems that know the location and velocity of the vehicles are provided with a suitable means of inter-vehicle communication, it becomes possible to use such information in a collision detection and avoidance system. Various rudimentary attempts at such systems have been proposed in the art, each suffering from various drawbacks. This disclosure addresses these drawbacks and proposes a system that solves the problems of the prior art.

### SUMMARY OF THE INVENTION

Disclosed herein are systems and methods for detecting a potential collision between a plurality of vehicles and alerting the operator to the potential collision. If the operator fails to heed the alert, the system may also assume control of the vehicle until the dangerous situation is passed. In connection with these systems, each vehicle is equipped with a telematics system that defines a safe perimeter around the vehicle. The safe perimeter is constantly changed in response to the velocity and acceleration of the vehicle. The telematics system is in communication with the telematics systems of other vehicles in the vicinity and the systems exchange data about the current extent of their safe perimeters. If a telematics system detects the impingement of one of the other safe perimeters into its safe perimeter, the alert is triggered.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a vehicle communication system for facilitating wireless communication between vehicles.

FIG. 2 illustrates a typical vehicle telematics system with which the collision detection and avoidance system of the present invention may be used.

FIG. 3 illustrates multiple vehicles equipped with a collision detection and avoidance system according to the present invention traveling on a network of streets.

FIG. 4 illustrates a plurality of vehicles equipped with a collision detection and avoidance system according to the present invention traveling in a safe scenario.

FIG. 5 illustrates a plurality of vehicles equipped with a collision detection and avoidance system according to the present invention traveling in an unsafe scenario.

### DETAILED DESCRIPTION

Disclosed herein is a system for detecting a potential collision hazard between two (or more) vehicles and providing an alert to the operators of the vehicles. One critical aspect of such a system is the concept of a dynamic safe perimeter around the vehicle. The shape and size of the safe perimeter may be constantly changed in response to the velocity (i.e., speed and direction of travel) of the vehicle as well as its acceleration (i.e., the rate of change of the vehicle's velocity). Before explaining the details of such an embodiment, an exemplary vehicle telematics system in which such a system can be used is described in some detail, with details of the inventive implementations to follow. Not all features of the described system are necessary to implement the potential collision detection and alert system described herein, but are shown nonetheless to illustrate generally features of typical telematics systems.

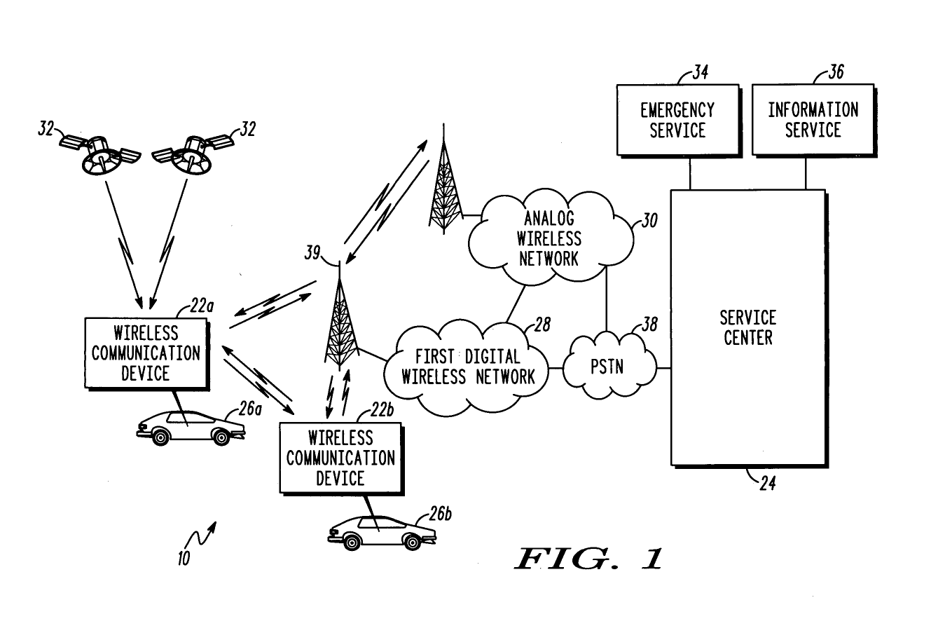

FIG. 1 shows an exemplary vehicle-based communication and informational system 10. In this system, vehicles 26 are equipped with wireless communication devices 22, which can wirelessly transmit or receive information to or from a transceiver tower coupled to a digital wireless network 28, which in turn may further transmit information to or receive information from an analog wireless network 30 if necessary or appropriate. Moreover, the wireless communication devices 22 may receive information from satellites 32, which is particularly useful in conjunction with GPS capabilities of the disclosed system which will be discussed in further detail later. Ultimately, either network may be coupled to a public switched telephone network (PSTN) 38 on route to a service center 24, which ultimately acts as the host for the communication system 10. As well as administering communications between vehicles 26 wirelessly connected to the system, and providing information to each vehicle 26 on an individualized basis, service center 24 can provide other services to the vehicles 26, such as emergency services 34 or other information services 36 (such as restaurant services, directory assistance, mapping programs, etc.). Alternatively, and particularly advantageous to the present invention, the vehicles 26 may be equipped for direct inter-vehicle communication. This direct, inter-vehicle communication may be effected by any number of means, including various radio frequency (RF) networking techniques, which are known to those skilled in the art.

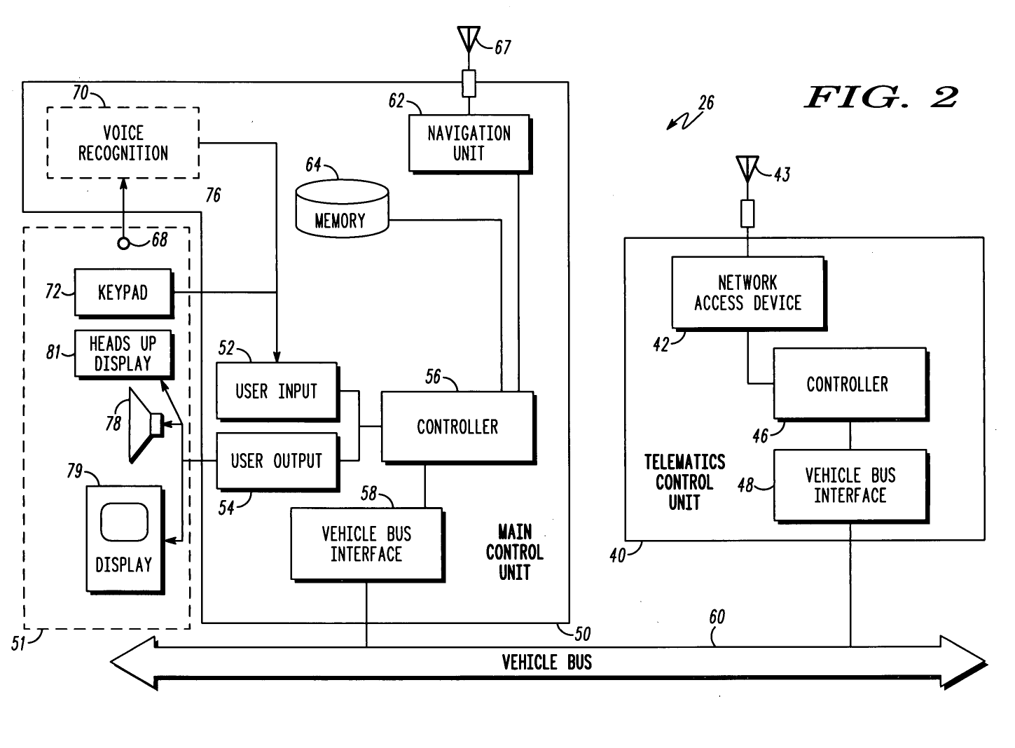

Further details of the electronics within vehicle 26 are shown in FIG. 2. The electronics include a main control unit 50 and a telematics control unit (TCU) 40. The main control unit 50 controls and administers communication and informational processing within the vehicle, and interfaces with or includes a user interface 51 with which the vehicle occupants interacts to send or receive communications or information. The main control unit 50 may include a microphone 68, a keypad 72, speaker(s) 78, and a display 79. These components within the user interface 51 may be integrated into a single unit (and, for example, integrated within the dashboard of the vehicle), or may be distributed throughout the vehicle. For example, the speakers 78 may comprise the standard radio speakers or may constitute a dedicated speaker or speakers. Additionally or alternatively to the display 79, the main control unit 50 may include a “heads up display” module 81 for visibly displaying information from the system via reflection from the front windshield as is known.

The main control unit 50 also comprises a navigation unit 62, which may include a Global Positioning Satellite (GPS) system for allowing the vehicle's location to be pinpointed, which is useful in the context of the invention for reasons to be explained later. As is known, the navigation unit 62 communicates with GPS satellites (such as satellites 32) via a receiver 67. Ultimately communications and information are processed by a controller 56. A memory 64 is coupled to the controller 56 to store data and processes for use in the system, such as, for example, the anti-collision system disclosed herein. The controller 56 also communicates via a vehicle bus interface 58 to a vehicle bus 60, which carries information and other data pertinent to vehicle operation throughout the vehicle.

TCU 40 is similarly coupled to the vehicle bus 60, and hence the main control unit 50. The TCU 40 is essentially responsible for sending and receiving voice or data communications to and from the vehicle. TCU 40 comprises a telematics controller 46 to organize such communications, and a network access device 42 which include a wireless transceiver 43. Although shown as separate components, one skilled in the art will recognize that aspects of the main control unit 50 and the TCU 40 can be combined or swapped.

Alternatively, and although not shown in the Figures, the TCU 40 could be coupled to another device present in the vehicle having wireless capability. For example, the vehicle occupant's cell phone may be used for this purpose, which may be wired to the TCU 40 and/or in wireless communication with the TCU 40 (e.g., using Bluetooth technology). Moreover, the GPS capability when using such an alternative device such as a cell phone may reside in the cell phone or in the TCU 40. Thus, the TCU 40 need not necessarily itself contain a wireless access device.

Additionally, another useful feature in connection with the potential collision detection and warning system described herein is the ability for vehicle telematics systems to communicate with similar systems in other vehicles having a certain location characteristic. For example, it is obviously desirable for collision detection and avoidance purposes if vehicles that are traveling on the same roadway be in communication with each other once they are within a certain proximity. Conversely, vehicles traveling on the other side of a divided highway present substantially less, if any, collision hazard and thus it is not necessarily desirable for these vehicles to be in communication. Alternatively, if the highway is not divided, there is a collision hazard and it is desirable for these vehicles to communicate. Similarly, it may be desirable for vehicles traveling on intersecting streets to be in communication when they are both approaching the intersection, but not once one or the other has passed the intersection. One suitable system for establishing communication between vehicles based on location and direction of travel is described below.

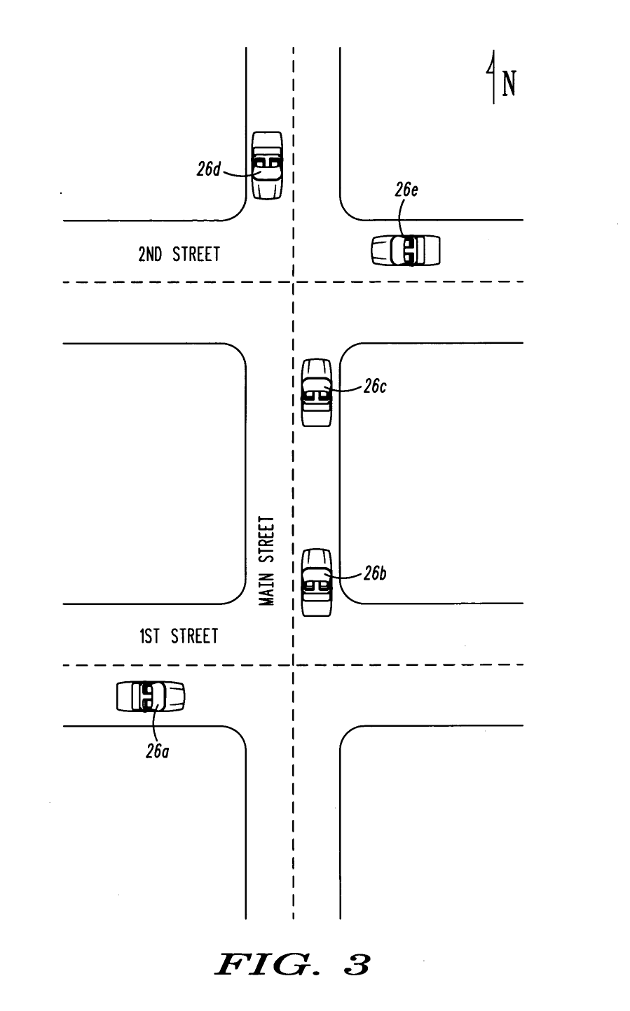

FIG. 3 shows various users each able to potentially communicate with the system. Five users 26 are shown in this example, three being located on a roadway (“Main Street”), and two being located on cross streets (“1^{st} and 2^{nd} Streets). All users have user interfaces 51 similar to those disclosed in FIG. 2. User 26a is headed eastbound on First Street. Users 26b and 26c are traveling northbound on Main Street, while user 26d is traveling southbound on the same street. User 26e is headed westbound on Second Street.

The various ways in which the users 26 can participate in or receive communications from other user is dictated on the basis of their locations and/or orientations (headings). The locations and/or headings of user 26a-e may be tracked by the service center 24 (FIG. 1). Alternatively, vehicles 26 may be communicating directly with each other in a peer-to-peer configuration. In either case, a telematics system aboard each vehicle transmits information regarding the location (e.g., longitude/latitude), heading (or orientation), speed, and identity of the users to certain other users on a periodic basis as explained further below. Such location, heading, and identity information for a particular user may be formatted in any number of ways.

Receipt of such information allows communications to be tailored for individual users based on a location or heading (orientation). For example, for collision detection and avoidance, vehicle 26a needs only to communicate with vehicle 26d. On the other hand, vehicle 26e needs to be communicating with vehicle 26d and vehicles 26b and 26c. Vehicles 26b and 26c will necessarily be in communication with each other, but may or may not need to be in communication with vehicle 26d depending on relative speeds and how the road is divided. To determine how the road is divided, the system may advantageously be integrated with a map database, various implementations of which are known to those skilled in the art.

The system described in the preceding paragraphs may be readily implemented by one skilled in the art to allow for direct inter-vehicle communication based on location, heading and other information. For example, if the vehicles are interconnected by a packet-based network, the systems may exchange data packets containing relevant location, heading and other information and the telematics systems may then determine whether it is appropriate to maintain a communication link between the vehicles based on such information.

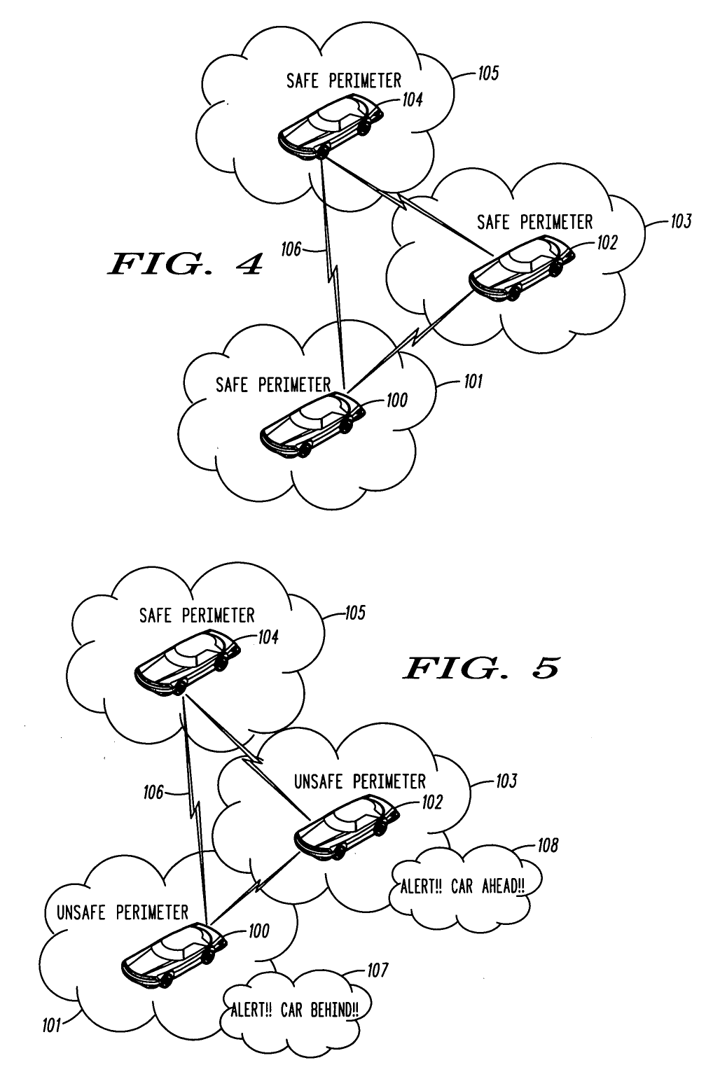

With these concepts understood, embodiments of the invention can be set forth with more clarity. FIG. 4 shows a plurality of vehicles 100, 102, and 104. Each of these vehicles has defined around it a safe perimeter (or “bubble”) 101, 103, and 105. Additionally, the vehicles are in communication with each other using some form of wireless networking 106. Wireless network 106 may be implemented directly between the vehicles by any of a variety of wireless communication systems that are known to those skilled in the art. Radio frequency (RF) networking is believed to be a particularly advantageous method of implementing the present invention. Inter-vehicle communication may also be accomplished by having each vehicle communicate with a base-station 39 (FIG. 1) or server 24 (FIG. 1) that is in communication with the other vehicles as described above. Selection and implementation of a particular technology to implement the inter-vehicle communication is an ordinary design choice that can be made by one having ordinary skill in the art weighing various factors and goals. The system of the present invention is equally suitable for use with any of these technologies.

Each of the safe perimeters 101, 103, and 105 disposed about their respective vehicles is dynamically defined in shape and size by the vehicle's velocity (speed and direction of travel). The bubble may also be defined by the vehicle's acceleration (rate of change of speed and/or direction of travel). For example, the faster the vehicle's speed, the farther in front of the vehicle it is necessary to extend the safe perimeter. Similarly, if the vehicle is changing direction, i.e., turning, it is desirable to extend the safe perimeter farther in the direction of the turn. If the vehicle is traveling straight, it is usually not necessary for the bubble to extend very far from the vehicle to the left or right, because the vehicle is not traveling in this direction. However, it may be desirable to extend the perimeter to the sides when the vehicle is in proximity to an intersection to provide advanced warning of a potential side impact form a car traveling on the intersecting road. Various specific velocity and acceleration parameters for dynamically shaping and sizing the safe perimeter are contemplated. The selection and weighting of particular parameters is a design decision lying within the purview of one of ordinary skill in the art, and, as such, they are not set forth in detail here. In any event, the extent of the safe perimeter is easily calculated at the controller 56 by receiving speed, heading, location information from vehicle bus 60. Additionally, the extent of the safe perimeter may be updated dynamically in response to changes in such information.

With reference to FIG. 5, vehicles 100 and 102 have changed position such that their safe perimeters are overlapping. Particularly, vehicle 102 has approached the rear of vehicle 100. In response to this incursion, an alert message 107 is given to the operator of vehicle 100 warning of a vehicle approaching from behind. Similarly, an alert message 108 is given to the operator of vehicle 102 warning of a vehicle ahead. These alert messages may be in the form of various audio or visual warnings given to the operator, including, for example, warning lights, text messages on a display, and/or audible alerts such as warning chimes or verbal warnings, preferably through user interface 51. Additionally, it is possible for the telematics system of the vehicles to intervene as necessary if the warnings are not heeded. For example, the telematics system could send appropriate signals through the vehicle bus 60 to the driving electronics (not shown) to reduce the speed of vehicle 102 to allow vehicle 100 to pull away. In contrast to systems of the prior art, these warnings result from the encroachment of safe perimeter 103 corresponding to vehicle 102 into safe perimeter 101 corresponding to vehicle 100, and not because of the presence of an object in proximity to the vehicle. Because the system of the present invention relies on detecting the overlap of a safe perimeter around the vehicles rather than direct physical proximity of the vehicles, it is necessary for the vehicles to be in communication with each other, e.g., by using wireless network 106. This communication allows the vehicles to exchange information identifying the extent of their safe perimeters.

In a first embodiment, the telematics system in each vehicle must know the absolute position of the vehicle, for example using GPS. As is known to those having skill in the art, ordinary GPS signals may not allow the location of the vehicle to be determined with sufficient precision to accomplish the objectives of the present invention, and thus it is contemplated that such an embodiment would use differential GPS (DGPS) or another position refinement system known to those of ordinary skill in the art. Such systems are discussed in detail in U.S. Pat. No. 6,405,132 to Breed et al. and in published U.S. Patent application 2002/0198632 also to Breed et al., each of which is hereby incorporated by reference.

It is also necessary for the telematics system in each vehicle to know the velocity of the vehicle. Based on the velocity, and possibly the acceleration, the telematics system determines the extent of the safe perimeter around the vehicle. Once determined, coordinates sufficient to identify the boundaries of the safe perimeter are transmitted via the wireless network 106 to other vehicles in proximity. Once a telematics system in a particular vehicle has received coordinates identifying the boundaries of bubbles corresponding to vehicles in the proximity, it can compare these bubbles to its own and determine whether there is any overlap. If so, an appropriate warning can be given to the operator of the vehicle. This process is periodically repeated as the vehicles travel and different vehicles approach or move away from each other.

As discussed briefly above, it is preferred that the vehicles communicate directly with each other, although the present invention also contemplates a system in which the vehicles communicate with each other via a base station 39 or server 24 (FIG. 1). In such an embodiment, the comparison to determine whether there is any overlap between the safe perimeters of the vehicles and the generation of alert messages may be done by the server or by the telematics system of each vehicle. Either technique is contemplated by the present invention.

In an alternative embodiment, it is not necessary for the telematics system to know its absolute position on the surface of the earth. In this embodiment the telematics system uses proximity detection sensors to locate nearby vehicles. Techniques that may be used for this include ultrasound, infrared laser, radar, and the like. Various proximity detection systems suitable for use with the present invention are disclosed in the Breed references discussed above and incorporated herein. Once the telematics system determines what vehicles are in its proximity and their location, the telematics system then correlates these detected vehicles with the messages it is receiving from vehicles in the vicinity in which these vehicles identify the extent of their safe perimeters. The telematics system, which has already computed the extent of the safe perimeter for its own vehicle, then compares the location of the received safe perimeters, originating from the detected targets, with its own safe perimeter and alarms the operator if there is an impingement, as in the preceding embodiment. Also, the communication between the vehicles is preferably direct between the vehicles, although systems involving a server or base station are also contemplated.

Furthermore, it is also contemplated that a system in accordance with any of the various teachings of this disclosure could also be equipped to detect other objects within its safe perimeter, such as stationary objects or other vehicles not equipped with the system described herein. In such a case, the alarm to the operator will necessarily be based on the object being within the safe perimeter rather than an overlap of safe perimeters.

Additional refinements of the system are also possible. For example, rather than a single safe perimeter around the vehicle, it is contemplated that a system in accordance with the teachings of this disclosure would include nested safe perimeters corresponding to different alert levels. For example, an impingement into the outermost safe perimeter might result in a notification to the operator, while an impingement into the innermost safe perimeter could result in the telematics system assuming control of the vehicle to avoid the hazard. Such a system could also provide an alarm based on other conditions such as relative velocity. A vehicle with a relatively small relative velocity might not trigger an alarm within a inward safe perimeter, while a vehicle with a relatively large relative velocity would trigger an alarm by impinging only on a more outward safe perimeter. As noted above, the selection and weighting of particular parameters of the safe perimeter are design decisions lying within the purview of one of ordinary skill in the art, and, as such, they are not set forth in detail here.

It should be understood that the inventive concepts disclosed herein are capable of many modifications. To the extent such modifications fall within the scope of the appended claims and their equivalents, they are intended to be covered by this patent.

1. A method of detecting a potential collision between two or more vehicles and alerting an operator of the potential collision comprising:
defining around a first vehicle a safe perimeter, the extent of the safe perimeter being determined according to one or more parameters of the first vehicle selected from the group consisting of: speed, direction of travel, acceleration, and change of direction; and
transmitting from the first vehicle to one or more other vehicles in proximity to the first vehicle the extent of the safe perimeter defined around the first vehicle.

2. The method of claim 1 further comprising:
receiving from at least one other vehicle the extent of a safe perimeter determined around the other vehicle; and
comparing the extent of the safe perimeter around the other vehicle to the extent of the safe perimeter around the first vehicle.

3. The method of claim 2 further comprising:
alerting the operator of the first vehicle if the extent of the safe perimeter around the first vehicle overlaps with the extent of the safe perimeter around the second vehicle.

4. The method of claim 3 further comprising:
assuming control of the first vehicle until the overlap between the safe perimeter around the first vehicle and the safe perimeter around the second vehicle is eliminated.

5. The method of claim 1 wherein the location of the first vehicle is determined using differential GPS.

6. The method of claim 1 wherein the step of transmitting from the first vehicle to one or more other vehicles in proximity to the first vehicle includes transmitting directly between the vehicles using a wireless RF network.

7. The method of claim 1 wherein the step of transmitting from the first vehicle to one or more other vehicles in proximity to the first vehicle includes transmitting indirectly between the vehicles using an intermediate base station.

8. The method of claim 2 wherein the step of transmitting from the first vehicle to one or more other vehicles in proximity to the first vehicle includes transmitting indirectly between the vehicles using an intermediate base station.

9. The method of claim 8 wherein the step of comparing the extent of the safe perimeter around the other vehicle to the extent of the safe perimeter around the first vehicle is performed at the intermediate base station.

10. The method of claim 1 further comprising the steps of detecting an object, determining the range to the object, and alerting the operator if the object is within the safe perimeter

11. A vehicle telematics system equipped to detect a potential collision between two or more vehicles and alert an operator to the potential collision comprising:
a differential GPS receiver;
a computer configured to receive information containing one or more vehicle parameters selected from the group consisting of: speed, direction of travel, acceleration, and change of direction, and to define a safe perimeter around the vehicle, the extent of which is based on one or more of the parameters; and
a transmitter for sending and the extent of the safe perimeter around the vehicle to one or more other vehicles in proximity to the vehicle.

12. The vehicle telematics system of claim 11 further comprising a receiver for receiving safe perimeter data from at least one other vehicle in proximity to the vehicle and wherein the programmable electronic device is further configured to compare the extent of the safe perimeter around the vehicle with the received data to determine whether the safe perimeter of the vehicle overlaps with the safe perimeter of the at least one other vehicle.

13. The vehicle telematics system of claim 12 further comprising an alert mechanism comprising one or more warning cues selected from the group consisting of: warning lights, textual messages, audible chimes, and verbal warnings.

14. The vehicle telematics system of claim 13 wherein the programmable electronic device is further configured to assume control of the vehicle in the event a warning cue is not heeded by the operator.

15. The vehicle telematics system of claim 11 wherein the transmitter is configured for direct vehicle-to-vehicle communication.

16. The vehicle telematics system of claim 11 wherein the transmitter is configured for indirect vehicle-to-vehicle communication using an intermediate base station.

17. The vehicle telematics system of claim 11 further comprising a proximity detector configured to detect an object and determine its range, wherein the programmable electronic device is further configured to determine whether the detected object is with in the safety zone and alert the operator if the detected object is within the safe perimeter.

18. A system for detecting and preventing a potential collision between two or more vehicles comprising:
means for determining the position of a vehicle;
means for defining around the vehicle safety perimeter, the extent of which is based on one or more operating parameters of the vehicle;
means for transmitting to another vehicle data including the position of the vehicle and the extent of the safety perimeter around the vehicle;
means for receiving from at least one other vehicle data including the position of the at least one other vehicle and the extent of a safety perimeter around the at least one other vehicle; and
means for comparing the safety perimeter around the first vehicle to the safety perimeter around the at least one other vehicle to determine whether the safety perimeters overlap.

19. A method of detecting and avoiding a potential collision between two or more vehicles comprising:
detecting the presence of a second vehicle presenting a potential collision hazard to the first vehicle;
calculating the extent of a safe perimeter around the first vehicle;
establishing a communications link with the second vehicle;
receiving from the second vehicle data comprising the extent of a safe perimeter around the second vehicle;
comparing the extent of the safe perimeter around the first vehicle and the extent of the safe perimeter around the second vehicle; and
alerting the operator of the first vehicle if the safe perimeter around the first vehicle overlaps with the safe perimeter around the second vehicle.

20. The method of claim 19 further comprising the step of determining the range from the first vehicle to the second vehicle.
